(19) United States
(12) Patent Application Publication
(10) Pub. No.: US 2004/0230998 A1
(43) Pub. Date: Nov. 18, 2004

(54) Hybrid circuit for broadband data service provisioning

(75) Inventors: Richard Bruce Webb, Austin, TX (US); Hichem Besbes, Austin, TX (US)

Correspondence Address: HAMILTON & TERRILE, LLP, P.O. BOX 203518, AUSTIN, TX, 78720, US

(73) Assignee: Celite Systems, Austin, TX (US)

(21) Appl. No.: 10/439,397

(22) Filed: May 16, 2003

(51) Int. Cl. H04N 7/173

(52) U.S. Cl. 725/127; 725/119; 725/121; 725/105

(57) ABSTRACT

A shared hybrid circuit for use in provisioning a communication system. In the method and apparatus of the present invention, a single shared hybrid separates transmitted and received signals for multiple transmission pathways between the distribution equipment and the customer premises equipment. In addition, the shared hybrid circuit of the present invention provides a method and apparatus to cancel a component of a downstream broadcast signal from a composite upstream/downstream signal detected at a node, thereby providing a significant reduction in echo and for the upstream transmission from a customer premises equipment transmitter. The present invention results in a significant cost savings over conventional hybrid circuits since a single shared hybrid can be used in provisioning service for many subscribers.

This application is related to application Ser. No. 10/137,624, entitled Digital Subscriber Head End filed on May 2, 2002, which by this reference is incorporated herein for all purposes. This application is also related to application Ser. No. 10/376,407, entitled Impedance-Matched Interface for Broadband Data Service Provisioning filed on Feb. 28, 2003, which by this reference is incorporated herein for all purposes.

### BACKGROUND

1. Technical Field

The present invention relates generally to broadband data communication systems. More specifically, the present invention provides an improved method and apparatus for efficient provisioning of broadband data services using an improved hybrid circuit.

2. Background

Most of the current systems for providing broadband Internet access are complex and expensive to deploy. As a result, the deployment of many broadband services, particularly digital subscriber line (DSL) service, has fallen far short of expectations.

Many broadband service systems, such as DSL, are based on the same telephone subscriber loop that is used to provide “Plain Old Telephone Service (POTS)” and generally coexists with POTS service on the same twisted pair cable, offering simultaneous analog/digital services. In current systems for provisioning DSL, a digital subscriber line access multiplexer (DSLAM) is deployed at the central office (CO) and a relatively high power signal is transmitted over an F1/main feed distribution network that provides service to various subscriber groups.

A “hybrid circuit” serves as the interface between the DSL system and the two-wire copper telephone line. The hybrid circuit serves two main purposes: 1) to interface the analog front-end (AFE) to the line (via the coupling method), and 2) to separate transmit (Tx) and receive (Rx) signals between the various system components. Basically, the hybrid circuit operates as a differential amplifier in the Tx direction and a passive network in the Rx direction.

One of the major problems that must be overcome in the operation of a broadband system is the cancellation of Tx “echo” signals that appear in the Rx path. Conventional solutions to this problem require a separate hybrid circuit for each transmission pathway between the broadband distribution equipment and the customer premises equipment (CPE), thereby increasing the cost of provisioning broadband service. Moreover, in systems where the downstream broadband signal is continuously broadcast, the upstream transmissions from the CPE transmitter are degraded by the broadcast transmit signal.

### SUMMARY OF THE INVENTION

The present invention overcomes the shortcomings of the prior art by providing an improved hybrid circuit for use in provisioning a communication system, such as a broadband system. The shared hybrid circuit of the present invention results in a significant cost savings over conventional hybrid circuits since a single shared hybrid can be used to separate transmitted and received signals for multiple transmission pathways between the broadband distribution equipment and the customer premises equipment. In addition, the shared hybrid circuit of the present invention provides a method and apparatus to cancel a component of a downstream broadcast signal from a composite upstream/downstream signal detected at a node, thereby providing a significant reduction in echo and an increase in the quality of the upstream transmission from a customer premises equipment transmitter.

In one embodiment of the present invention, a summing circuit is operable to detect a composite signal comprising a downstream broadcast signal from broadband distribution equipment and an upstream transmission from a CPE transmitter. A duplicate of the downstream broadcast signal component is provided to the summing circuit and is subtracted from the composite signal detected at the node. The resulting signal is transmitted upstream to the broadband access manager. The method and apparatus of the present invention is operable to handle upstream signals from multiple CPE transmitters on multiple pathways using a plurality of switches controlled by a timing control to sequentially detect composite upstream/downstream composite signals at a plurality of nodes on the various transmission pathways.

For purposes of illustration, some aspects of the present invention will be described in connection with a particular broadband service, such as DSL. The advantages described herein, however, can be used to reduce cost and improve performance for many other systems for providing broadband services to subscribers.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a prior art distribution area.

FIG. 2 is a system diagram illustrating a prior art embodiment of a DSL system for downstream and upstream broadcasting for a plurality of users.

FIG. 3 is a system diagram illustrating an embodiment of a broadband distribution system showing the broadband service distribution equipment connected to a cross-connect box in a subscriber distribution area.

FIG. 4 is a system diagram illustrating direct tap interconnections within a cross-connect box for connecting broadband distribution equipment to provide broadband services to subscribers in the distribution area.

FIG. 5 is a system block diagram of a DSL distribution system utilizing an embodiment of a shared hybrid circuit in accordance with the present invention.

FIG. 6 is a general illustration of the impedances for the F1 and F2 distribution cables relative to the serving area interface cross-connection box in the subscriber distribution area.

### DETAILED DESCRIPTION OF THE INVENTION

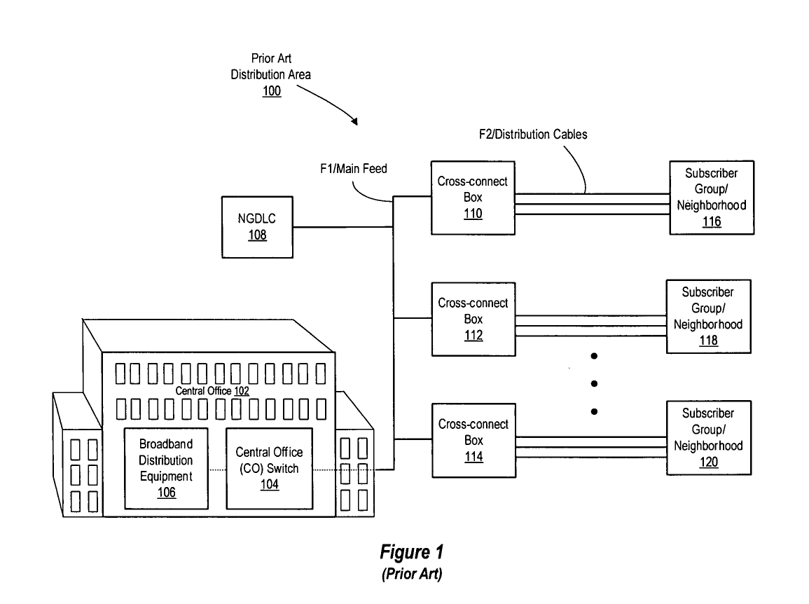

FIG. 1 is a system diagram illustrating an embodiment of a prior art distribution area 100 for providing broadband service to a plurality of subscribers. A central office 102 provides an F1/main feed distribution that may be employed to service different subscriber groups. In the illustration of FIG. 1, the F1/main feed provides connectivity to a number of serving area interface (SAI) cross-connect boxes 110, 112, . . . , and 114. Each of the cross-connect boxes 110, 112, . . . , and 114 provide servicing via F2/distribution cables to subscriber groups/neighborhoods 116, 118, . . . , and 120, respectively. One or more of the cross-connect boxes 110, 114, . . . , and 116 may employ a next generation digital loop carrier (NG-DLC) 108.

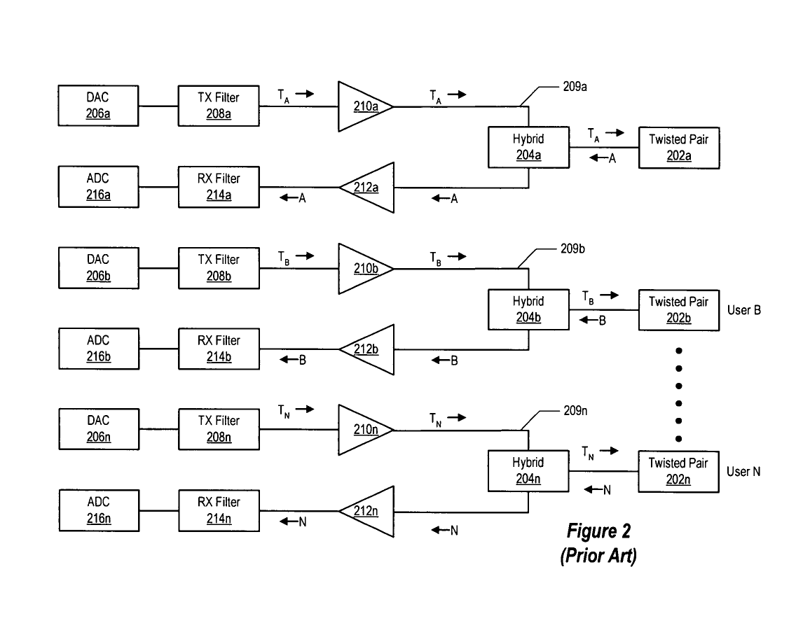

FIG. 2 is an illustration of a prior art architecture for providing DSL service from a cross-connect box to a plurality of end Users A, B, . . . N. Downstream transmission for Users A, B, . . . N is illustrated by arrows T_{A}, T_{B} and T_{N}, respectively. Upstream transmission for Users A, B, . . . N is illustrated by arrows “A,” “B” and “N,” respectively. Referring to the illustration for User A, the twisted pair 202a at the user site is connected to a hybrid connector 204a that provides interconnection of shielded copper twisted pair wires with other transmission media within the DSL distribution network. Data transmitted downstream is received by the digital-to-analog converter 206a and is then passed through the transmitter filter 208a and through the line driver 210a to the hybrid connector 204a and finally to the User A twisted pair 202a. Data transmitted upstream passes from the User A twisted pair 202a through the hybrid circuit 204a to the receiver function 212a. The data is then transmitted to the receiver filter 214a and the analog-to-digital converter 216a to the DSL network. In the prior art architecture illustrated in FIG. 2, it is necessary to provide duplicate system components for each of the end users. The various architectures of the present invention, discussed in greater detail below, allow a significant reduction in the number of components needed to provide DSL service to a plurality of users.

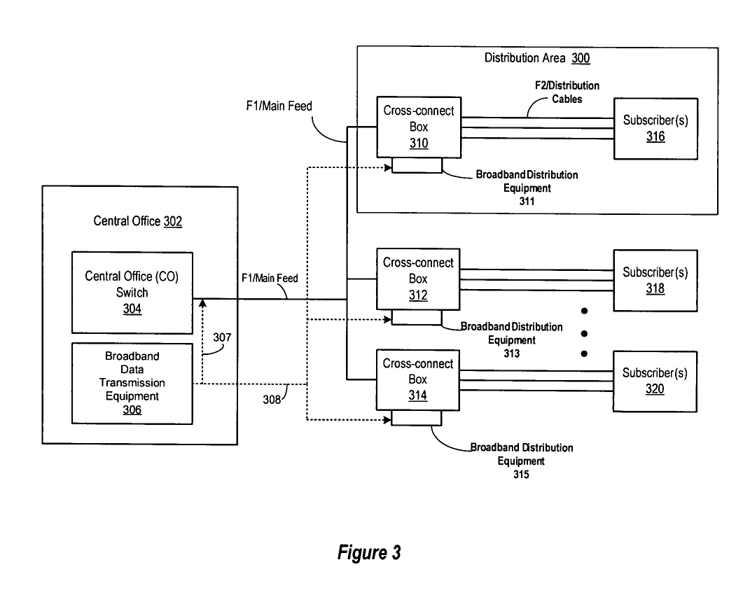

FIG. 3 is a system diagram illustrating an embodiment of a distribution area 300 that is configured in accordance with the present invention. A central office 302 provides an F1/main feed cable to distribution points within the distribution area 300. The distribution points typically include cross-connect boxes, shown as cross-connect box 310, cross-connect box 312, and cross-connect box 314. The cross-connect boxes connect the F1 main feed cables to F2 distribution cables that provide service to a large number of subscribers, shown as subscriber(s) 316, subscriber(s) 318, . . . , and subscriber(s) 320.

In the embodiment shown in FIG. 3, broadband distribution equipment is connected to each of the cross-connect boxes 310-314. For example, broadband distribution equipment 311 is attached to the cross-connect box 310. The broadband distribution equipment 311 is operable to provide broadband service to the subscriber(s) 316. As will be described in greater detail below, the interconnections of the broadband distribution equipment within each of the cross-connect boxes can be performed by “tapping off” each active F1/F2 pair within the cross-connect loop. In some embodiments, F2/distribution cable pairs are communicatively coupled to each subscriber even though only a fraction of the connections are actually used at the time the broadband distribution equipment is installed. Since the subscriber pairs are already connected, subsequent users can be provided with broadband service remotely, without the need for disrupting existing service.

By using the configuration illustrated in FIG. 3, broadband service capabilities may be offered to the subscriber(s) 316, 318, . . . , and 320 without a radical overhaul of the system's communication hardware or significant man-hours to enable those services. Moreover, the broadband service can be provided with far less power than is currently required using broadband distribution equipment that is connected to the distribution network at the central office.

Broadband signal transmission to the broadband distribution equipment 311, 313, . . . , 315 at the cross-connect boxes 310, 312, . . . , and 314 can be provided via broadband data transmission equipment 306 that can be implemented in a number of different configurations. For example, the broadband data can be transmitted to the broadband distribution equipment 311, 313, . . . , 315 using dedicated cables in the F1 main feed to transport Ti or other broadband service, as illustrated by the pathway 307. In this embodiment, a predetermined number of cable pairs in the F1 bundle are dedicated for broadband data transmission. In addition, some of the F1 cable pairs can be dedicated to provide power to the broadband distribution equipment and/or can be used by the hybrid circuit, as described in greater detail below. The broadband data bandwidth carried over the F1 is aggregated and distributed to subscribers by the broadband distribution equipment 311, 313, . . . , 315. Alternatively, the broadband data can be transmitted to the broadband distribution equipment 311, 313, . . . , 315 using a separate transmission pathway illustrated by reference numeral 308. The separate transmission pathway can be implemented using a number of techniques known in the art, including fiber optic media or point-to-point radio transmission.

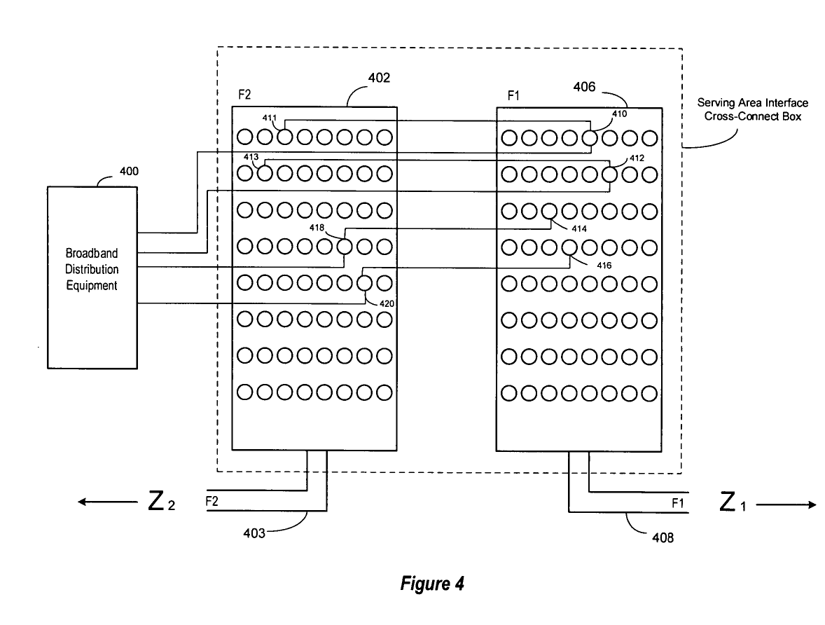

FIG. 4 is a system diagram illustrating an embodiment of interconnections between the F1 and F2 cables and the broadband distribution equipment 400. In one embodiment, the F1 cables can be connected directly to the broadband distribution equipment 400 as illustrated by the connection of terminals 410 and 412. The F1 terminals 410 and 412 are also connected to F2 terminals 411 and 413 that correspond to subscribers. Alternatively, the various F1 cables can be connected to the F2 cables, which are further connected to the broadband distribution equipment 400. For example, the F1 cable terminals 414 and 416 are shown connected to F2 cable terminals 418 and 420, respectively, which are further connected to the broadband distribution equipment 400. In each of the embodiments discussed above, the broadband distribution equipment 400 is “tapped” to the respective F1/F2 connections resulting in a parallel impedance relationship that will be discussed in greater detail below.

As was discussed above, each of the F1 cables can be connected to respective F2 terminals and to broadband distribution equipment 400 even though the customer premises equipment corresponding to a particular F2 terminal may not be activated at the time the connection is initially established. Various users can subsequently be provided with DSL service by remotely activating the broadband service without the need to have a technician physically return to the cross-connect box, thereby reducing the cost of provisioning DSL service.

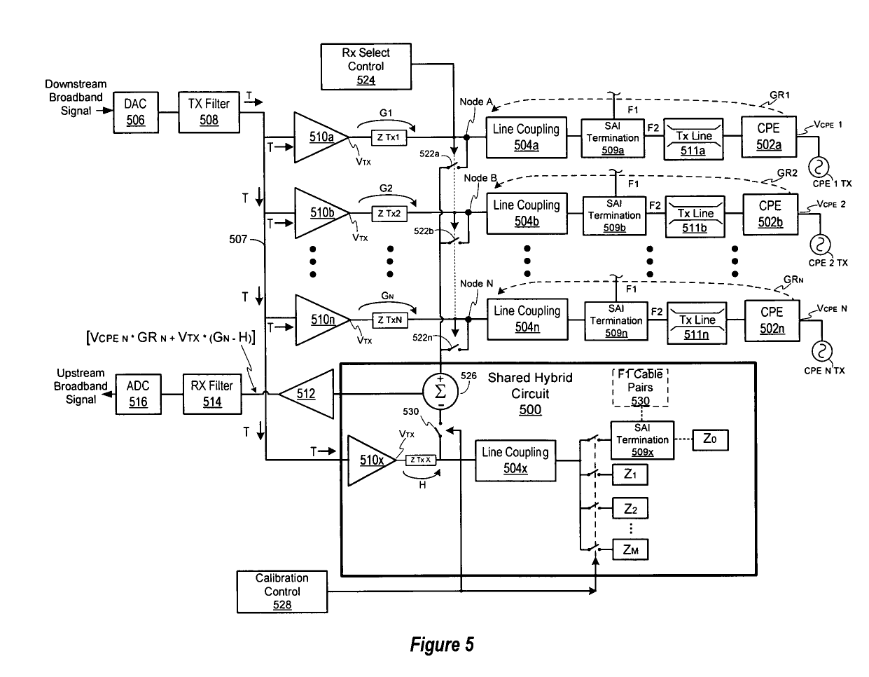

FIG. 5 is an illustration of an architecture for delivering DSL service using multipoint downstream broadcast and frequency and/or time-division multiplexing for upstream transmission. Data transmitted downstream is received by the digital to analog converter 506 and is then passed through the transmitter filter 508. The downstream transmitted data is carried on transmission line 507 and distributed to each of the users A, B . . . N, designated by CPE's 502a, 502b, . . . 502n, along the transmission path illustrated by the arrows labeled “T.” For example, downstream data for user A, illustrated by customer premises equipment (CPE) 502a, travels through line driver 510a and is coupled through line coupling 504a and SAI 509a and is then distributed on a transmission line 511a comprising F2 cable bundles. Upstream data transmitted from CPE 502a is generated in CPE transmitter, designated in FIG. 5 by CPE1TX which is transmitted through transmission line 511a and SAI 509a to the line coupling 504a.

A shared hybrid circuit 500 receives a composite signal at Node A comprising the combination of a downstream broadcast signal's echo from driver 510a and an upstream transmission from CPE₁Tx. The downstream component of the composite signal detected by the shared hybrid at node A comprises gain GI which is defined by the transmit voltage, Vtx, at the output of driver 510a, the source impedance of driver 510a, illustrated by Z_{Tx1}, and by the combined impedance of all of the components in the transmission pathway between Node A and the customer premises transmitter CPE₁Tx. The upstream component of the composite signal detected at Node A is characterized by gain GR1 which is defined by the upstream signal voltage, VCPE1, the combined impedance of all of the components between Node A and the CPE transmitter CPE₁Tx, and by the source impedance, Z_{Tx1}, of the driver 510a. The composite signal at node A is transmitted to the shared hybrid circuit 500 through switch 522a which is controlled by a receiver select control 524. The broadband distribution system illustrated in FIG. 5 can operate in a time-division multiplexing mode by controlling the operation of the switches 522a, 522b, . . . , 522n to coordinate the arrival at the summing circuit 526 of the upstream transmissions from the CPE transmitters CPE₁TX, CPE₂ TX, . . . , CPE_{N} TX.

The summing circuit 526 also receives a compensation signal equal to the magnitude of the downstream broadcast signal via line driver 510x that is provided as a negative input to the second input port of the summing circuit. The magnitude of the compensation signal that is provided to the negative input of the summing circuit 526 is defined by a transfer function “H” as a function of Vtx, the source impedance of the driver 510x, Z_{TXX} and by the compromise impedance connected to the second input of the summing circuit as discussed below. The output of the summing circuit 526 is provided to receiver driver 512 and the signal is transmitted upstream via receiver filter 514 and analog to digital converter 516.

The magnitude of the downstream Tx signal seen at node A is determined by a voltage divider relationship characterized by Vtx, Vcpe_{N}, the source impedance line driver 510a (Z_{Tx1}), and the combined impedance of the line components between the CPE 502a and Node A. To ensure that the component of the downstream transmit signal provided to the negative input of the summing circuit 526 correctly compensates for the component of the transmit signal seen at Node A, a compensating impedance is connected to the output of the line driver 510x. This compensating impedance is defined by the combination of the impedance of the line coupling 504x and one or more of a plurality of compromise impedances, Z1, Z2, . . . , Zm. The value of the compromise impedance is selected such that the combination of the impedance of the line coupling 504x and the impedance provided by one or more of the compromise impedances Z1, Z2, . . . , Zm will be approximately equal to the combined impedance of the elements between the CPE 502a and the Node A as discussed above. A calibration control 528 can be used to calibrate the shared hybrid to ensure that the proper compromise impedance is selected to optimize performance for each of the transmission pathways for CPEs 502a, 502b, . . . , 502n. The switch 530 at the negative input to the summing circuit 526 is closed during normal operation of the shared hybrid circuit 526, but is opened when the calibration procedure is implemented.

The composite signal at the output of the receiver driver 512 is determined by the equation:

[V_{CPE N}*G_{RN}+V_{TX}*(G_{N}−H)]

The term (G_{N}−H) will be driven toward zero if the transfer functions of the downstream broadcast signal and the gain of the signal provided to the negative input of the summing circuit 526 are approximately equal. If this result is achieved, the echo effects of the downstream broadcast will be essentially eliminated.

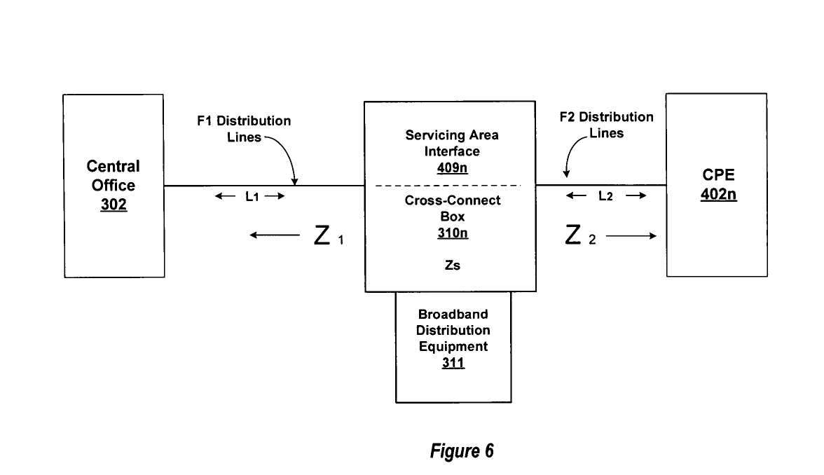

FIG. 6 is a generalized illustration of the equivalent impedances resulting from line lengths of the F1 and F2 distribution cables connected to the SAI 409n and cross-connect box 310n in the subscriber distribution area. The SAI 409n has a source impedance Zₛ. The impedance of the portion line from the SAI 409n to the central office 302 is Z₁. The impedance of the portion of the line from the SAI to the customer premises equipment of the subscriber 402n is Z₂.

In some operating environments, the length of the F1 cables may be relatively short, thereby creating a situation where the echo rejection is degraded due to the impedance characteristic of the F1 cable bundle, thereby resulting in undesired signal errors. In one embodiment of the present invention, this problem is solved by attaching an additional available F1 cable pair in parallel with the compromise impedance. Referring again to FIG. 5, the shared hybrid circuit is shown to comprise an SAI termination 509x that is connected to F1 cable pairs 530 that can be used to generate a supplemental impedance to reduce error signals. The SAI termination 509x is also connected to a compromise impedance Z₀ that approximates the impedance of the components between the SAI termination and the CPEtx in the various transmission pathways. For example, Z₀ can be used to approximate the combined impedances of the Tx Line 511a, and the CPE 502a. The SAI termination 509× and F2 cable pairs 350 can be selectively connected to the line coupling 504x—either alone, or in combination with compromise impedances Z1, Z2, . . . , Zm—to generate an appropriate impedance to compensate for impedance problems associated with short F1 cables as discussed above.

In view of the above detailed description of the invention and associated drawings, other modifications and variations will now become apparent to those skilled in the art. It should also be apparent that such other modifications and variations may be effected without departing from the spirit and scope of the invention.

What is claimed is:

1. A method of using a single hybrid circuit shared by multiple ports in a broadcast transmission system, comprising:
receiving a first composite signal at a first port of a summing circuit in said shared hybrid circuit, said first composite signal comprising a first downstream signal and a first upstream data signal;
receiving a compensation downstream signal at a second port of said summing circuit of said shared hybrid circuit, said compensation downstream signal being substantially identical to said first downstream signal; and
transferring an upstream data signal from an output port of said summing circuit of said shared hybrid circuit, said upstream data signal being defined by the difference between said first composite data signal and said compensation downstream data signal.

2. The method according to claim 1 wherein said first composite signal is received by connecting said first port of said summing circuit to a first node in a first distribution path, said first downstream signal component of said first composite signal being defined by the transmit voltage, Vtx, at the output of a first line driver, by the source impedance, Ztx1, of said first line driver and by the combined impedance of a plurality of components between said first node and said customer premises equipment transmitter.

3. The method according to claim 2, wherein said first upstream signal component of said first composite signal is defined by the transmit voltage, Vcpe1tx, at the output of a first customer premises equipment transmitter, the combined impedance of a plurality of components between said first node and said customer premises equipment transmitter and by the source impedance Ztx1 of said first line driver.

4. The method according to claim 3, wherein said plurality of components between said first node and said customer premises transmitter comprises a servicing area interface cross-connect box establishing a connection between F1 distribution cables and F2 distribution cables.

5. The method according to claim 4, wherein said downstream compensation signal received at said second port of said summing circuit of said shared hybrid circuit is defined by the transmit voltage, Vtx, at the output of a compensation line driver and by the source impedance, ZtxX, of said compensation line driver and by a compromise impedance having a value approximately equal to the impedance of components in the transmission pathway between the node and the customer premises equipment transmitter.

6. The method according to claim 5, wherein said compromise impedance is comprised of at least two impedance elements selected from a plurality of compromise impedance elements.

7. The method according to claim 6, wherein said compromise impedances include at least one servicing area interface connection to a pair of F1 distribution cables and a compromise impedance (Z0) having a value approximately equal to the impedance of components in the transmission pathway between the cross-connect box and the customer premises equipment.

8. The method according to claim 1, wherein said first composite signal is received at said first port of said summing circuit during a first time interval and a second composite signal is received at said first port of said summing circuit during a second time interval, wherein said summing circuit is operable to generate a time-division-multiplexed output signal of combined upstream signal transmissions from a plurality of customer premises transmitters.

9. The method according to claim 8, wherein said compromise impedance is selected from a plurality of individual compromise impedance components, wherein the specific individual compromise impedance component connected to said second input of said summing circuit at a specific timing interval corresponds to the specific combined impedance of said plurality of components between said node and said customer premises equipment transmitter.

10. A shared hybrid circuit for use with a data services distribution system, comprising:
a summing circuit having a first input port, a second input port and an output port, said summing circuit being operable to transfer an output signal equal to the difference between the signal received in said first input port and the signal received in said second input port,
wherein said first input port receives a first composite signal comprising a first downstream signal and a first upstream signal;
wherein said second input port receives a compensation downstream signal that is substantially identical to said first downstream signal; and
wherein an upstream output signal is transferred from said output port, said upstream output signal being the difference between said first composite signal and said compensation downstream signal.

11. The shared hybrid circuit according to claim 10 wherein said first composite signal is received by connecting said first port of said summing circuit to a first node in a first distribution path, said first downstream signal component of said first composite signal being defined by the transmit voltage, Vtx, at the output of a first line driver and by the source impedance, Ztx1, of said first line driver and by the combined impedance of a plurality of components between said first node and said customer premises equipment.

12. The shared hybrid circuit according to claim 11, wherein said first upstream signal component of said first composite signal is defined by the transmit voltage, Vcpe1tx, at the output of a first customer premises equipment transmitter and the combined impedance of a plurality of components between said first node and said customer premises equipment transmitter and by the source impedance Ztx1 of said first line driver.

13. The shared hybrid circuit according to claim 12, wherein said plurality of components between said first node and said customer premises transmitter comprises a servicing area interface cross-connect box establishing a connection between F1 distribution cables and F2 distribution cables.

14. The shared hybrid circuit according to claim 13, wherein said downstream compensation data signal received at said second port of said summing circuit of said shared hybrid circuit is defined by the transmit voltage, Vtx, at the output of a compensation line driver and by the source impedance, ZtxX, of said compensation line driver and by a compromise impedance having a value approximately equal to the impedance of components in the transmission pathway between the node and the customer premises equipment.

15. The shared hybrid circuit according to claim 14, wherein said compromise impedance is comprised of at least two impedance elements selected from a plurality of compromise impedance elements.

16. The shared hybrid circuit according to claim 14, wherein said compromise impedance includes at least one servicing area interface cross-connect box establishing a connection between F1 distribution cables and F2 distribution cables.

17. The shared hybrid circuit according to claim 11, wherein said first composite signal is received at said first port of said summing circuit during a first time interval and a second composite signal is received at said first port of said summing circuit during a second time interval, wherein said summing circuit is operable to generate a time-division-multiplexed output signal of combined upstream signal transmissions from a plurality of customer premises transmitters.

18. The shared hybrid circuit according to claim 17, wherein said compromise impedance is selected from a plurality of individual compromise impedance components, wherein the specific individual compromise impedance component connected to said second input of said summing circuit at a specific timing interval corresponds to the specific combined impedance of said plurality of components between said node and said customer premises equipment transmitter.
